(19) United States
(12) Patent Application Publication
(10) Pub. No.: US 2002/0037699 A1
(43) Pub. Date: Mar. 28, 2002

(54) Radio communication system and electronic device search method

(76) Inventors: Koichi Kobayashi, Tachikawa-shi (JP); Yuji Uchigasaki, Hino-shi (JP)

Correspondence Address: Finnegan, Henderson, Farabow,, Garrett & Dunner, L.L.P., 1300 I Street, N.W., Washington, DC, 20005-3315, US

(21) Appl. No.: 09/948,582

(22) Filed: Sep. 10, 2001

(30) Foreign Application Priority Data
Sep. 21, 2000 (JP) 2000-287714

(51) Int. Cl. H04B 5/00

(52) U.S. Cl. 455/41; 455/450; 455/517

(57) ABSTRACT

Before formation of a piconet, a computer transmits a search signal for checking whether a communication partner desired by the user is present in the communicable zone. Upon receiving the search signal, the computer transmits a response signal to the search signal and causes an LED to emit light or causes a buzzer to generate a sound to indicate that the computer is present in the communicable zone. With this operation, the user of the computer can visually recognize the position where the computer is present.

### CROSS-REFERENCE TO RELATED APPLICATIONS

This application is based upon and claims the benefit of priority from the prior Japanese Patent Application No. 2000-287714, filed Sep. 21, 2000, the entire contents of which are incorporated herein by reference.

### BACKGROUND OF THE INVENTION

1. Field of the Invention

The present invention relates to a radio communication system and electronic device search method and, more particularly, to a radio communication system in which a radio communication network is formed by electronic devices having identical radio communication interfaces, and an electronic device search method.

2. Description of the Related Art

Conventionally, a technique called wireless LAN has been used as a technique of forming a radio communication network by electronic devices. This wireless LAN realizes radio communication using infrared rays or radio waves instead of cables.

In recent years, a short-distance radio communication technique called Bluetooth which allows radio connection of various kinds of electronic devices using a 2.45-GHz band has received a great deal of attention. As a use example, the respective persons in an office forms a radio communication network using personal computers or portable information devices (PDAs and the like) to exchange information. In the Bluetooth technology, a radio communication network formed by a plurality of electronic devices is called a piconet. One of the plurality of electronic devices that form the piconet serves as a master (parent) for managing the piconet and controlling the remaining electronic devices. The electronic devices other than the master are slaves (children) controlled by the master.

In addition to Bluetooth, a radio communication technique (interface standard) defined by IEEE802.11b, IEEE802.12, or IEEE802.15 is present.

Many electronic devices in the future, including a personal computer, portable information device, portable telephone, digital camera, and printer used in an office or home, are expected to have interfaces for realizing radio communication. In addition, the types of radio communication interfaces employed by electronic devices are not always identical, and the electronic devices may employ interfaces of different types.

In this case, electronic devices having no radio communication interfaces or electronic devices having interfaces of different types mix in an office or home. For this reason, it is difficult for the user to visually recognize one of a plurality of electronic devices of a communication partner of the electronic device of his/her own and discriminate it from the remaining devices.

In addition, in the radio communication technique such as Bluetooth, since the radio wave range is limited, communication cannot be performed if the electronic device of a communication partner is not present in the communicable zone. For this reason, it has to be always checked when the electronic device of the communication partner moves from the noncommunicable zone to the communicable zone. Even when it can be detected that the electronic device of the communication partner enters the communicable zone, the user can hardly recognize the location of the electronic device of the communication partner if a plurality of other electronic devices are present.

### BRIEF SUMMARY OF THE INVENTION

Accordingly, it is an object of the present invention to provide a radio communication system and electronic device search method, which allow a user to quickly and easily recognize the position of an electronic device as a radio communication partner before formation of a radio communication network.

According to one aspect of the present invention, there is provided a radio communication system comprising: a first electronic device transmitting a search signal for checking whether a communication partner of the first electronic device is present in a communicable zone; and a second electronic device transmitting a response signal to the search signal and generating an indicating signal indicating that the second electronic device is present in the communicable zone.

According to another aspect of the present invention, there is provided an electronic device search method applied to a radio communication system including first and second electronic devices capable of forming a radio communication network, the method comprising: first transmitting from the first electronic device a search signal for checking whether a communication partner of the first electronic device is present in a communicable zone; second transmitting from the second electronic device a response signal to the search signal when the second electronic device receives the search signal; and generating from the second electronic device an indicating signal indicating that the second electronic device is present in the communicable zone when the second electronic device receives the search signal.

According to still another aspect of the present invention, there is provided a radio communication device for communicating with another radio communication device, comprising: a radio communication unit executing ad hoc radio communication with the another radio communication device; and a signal output unit outputting a signal through the radio communication unit to the another radio communication device, the signal causing the another radio communication device to indicate that the another radio communication device is communicable when the another radio communication device is capable of executing ad hoc radio communication with the radio communication unit.

According to still another aspect of the present invention, there is provided a radio communication device for communicating with another radio communication device, comprising: a radio communication unit executing ad hoc radio communication with the another radio communication device; and a signal output unit outputting a signal through the radio communication unit to the another radio communication device, the signal causing the another radio communication device to generate a sound when the another radio communication device is capable of executing ad hoc radio communication with the radio communication unit.

According to still another aspect of the present invention, there is provided a radio communication device for communicating with another radio communication device, comprising: a radio communication unit executing ad hoc radio communication with the another radio communication device; and a signal output unit outputting a signal through the radio communication unit to the another radio communication device, the signal causing the another radio communication device to generate a light when the another radio communication device is capable of executing ad hoc radio communication with the radio communication unit.

According to still another aspect of the present invention, there is provided a radio communication system comprising: a first radio communication device and a second radio communication device capable of forming an ad hoc network, the first radio communication device comprising a first radio communication unit, and a signal output unit outputting a signal through the first radio communication unit, the signal inquiring whether the second radio communication device is communicable; and the second radio communication device comprising a second radio communication unit, and an indicating unit receiving the signal through the second radio communication unit and indicating that the second radio communication device is communicable, when the second radio communication device is capable of executing ad hoc radio communication with the first radio communication device.

According to still another aspect of the present invention, there is provided a method of searching a communicable partner before an ad hoc network is formed in a radio communication system including a first radio communication device and a second radio communication device, the method comprising: outputting a signal from the first radio communication device to the second radio communication device, the signal inquiring whether the second radio communication device is communicable; and receiving the signal and indicating that the second radio communication device is communicable by the second radio communication device, when the second radio communication device is capable of executing ad hoc radio communication with the first radio communication device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of a radio communication system according to the embodiments of the present invention;

FIGS. 2A and 2B are views for explaining the characteristic features of two notification modes prepared in each personal computer shown in FIG. 1;

FIGS. 3A and 3B are views for explaining the setting window for the two notification modes;

FIG. 4 is a view for explaining the setting window for two response modes prepared in each personal computer shown in FIG. 1;

FIG. 5 is a block diagram showing the hardware configuration of the personal computer shown in FIG. 1 with a PC card inserted;

FIG. 6 is a block diagram showing the hardware configuration of the personal computer shown in FIG. 1 without a PC card inserted;

FIG. 7 is a view showing another configuration different from the radio communication system shown in FIG. 1;

FIG. 8 is a block diagram showing the hardware configuration of an access point shown in FIG. 7;

FIG. 9 is a flow chart showing notification mode discrimination processing of a searching personal computer;

FIG. 10 is a flow chart showing processing when a search notification mode is set;

FIG. 11 is a flow chart showing processing when a communicable zone notification mode is set;

FIG. 12 is a flow chart showing response mode discrimination processing of a searching personal computer;

FIG. 13 is a flow chart showing processing when an Inquiry response mode is set; and

FIG. 14 is a flow chart showing processing when a Page response mode is set.

### DETAILED DESCRIPTION OF THE INVENTION

The embodiments of the present invention will be described below with reference to the accompanying drawing.

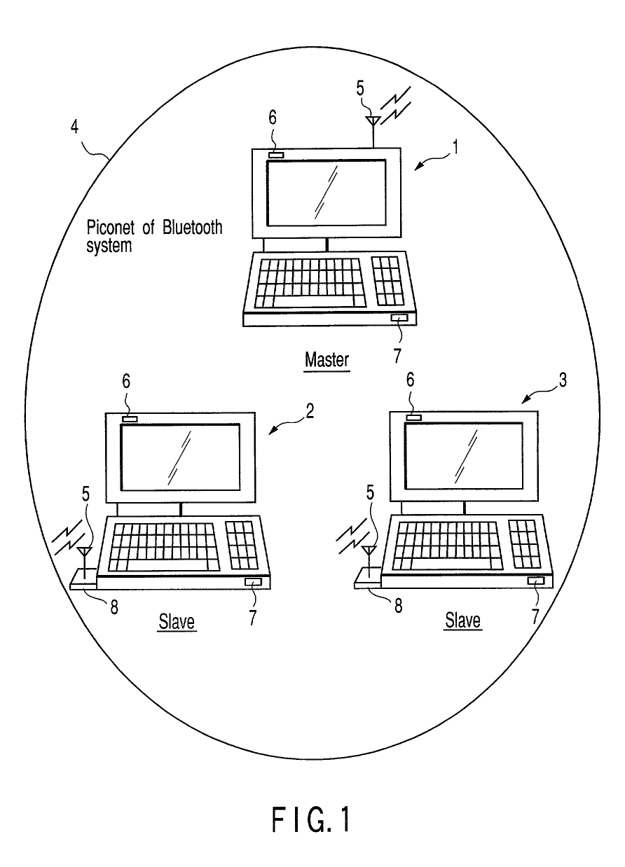

FIG. 1 is a view showing a configuration of a radio communication system according to the embodiments of the present invention.

This system is formed from personal computers (to be referred to as PCs hereinafter) 1 to 3. The PCs 1 to 3 respectively have Bluetooth radio communication functions (interfaces) and can form a radio communication network (piconet) 4 by the functions and execute ad hoc short-distance radio communication with each other.

Of the PCs 1 to 3, the PC 1 operates as a master for managing the piconet of the Bluetooth system and controls the remaining PCs 2 and 3. On the other hand, the PCs 2 and 3 operate as slaves controlled by the master, i.e., the PC 1.

The PC 1 has the Bluetooth radio communication function in its main body and executes radio communication through an antenna section 5. On the other hand, each of the PCs 2 and 3 has a PC card 8 which has the Bluetooth radio communication function and is inserted into the slot of the main body, and executes radio communication through the antenna section 5 provided on the PC card 8.

Each PC also has an LED (Light Emitting Diode) 6 as a light emitting element and a buzzer 7 as a sound generator. When the PC of a user is present in a communicable zone, the LED 6 and buzzer 7 are used to indicate the position of the PC to other PC users.

Before the piconet 4 is formed, each PC transmits to a PC of a communication partner a signal (a signal for searching for a communication partner) for inquiring whether the PC of the communication partner desired by the user is present in the radio communicable zone in accordance with an instruction from the user (Inquiry scan is performed). Upon receiving a signal responding to the inquiry signal, each PC transmits a signal representing a link request (Page scan is performed).

When the PC which has been asked whether it is present in the communicable zone is present in the communicable zone, the PC responds to the inquiry signal (Inquiry response is performed) and also causes the LED 6 to emit light (turns on or blinks the LED 6) or causes the buzzer 7 to generate a sound to indicate its presence. Instead of operating the LED 6 or buzzer 7 at this time, the LED 6 or buzzer 7 may be operated to respond to a link request signal subsequently sent from the inquiring PC (Page response is executed). Which of the LED 6 and buzzer 7 is to be operated (or whether both the LED 6 and the buzzer 7 are to be operated) can be freely set by the user.

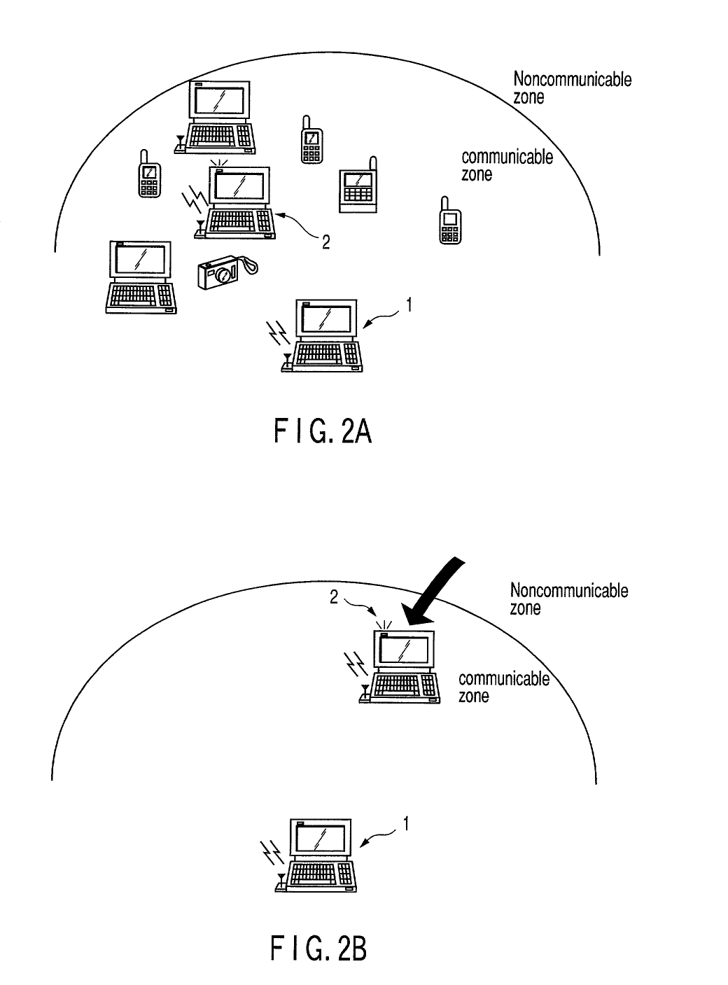

Each of the PCs 1 to 3 of this embodiment has a search notification mode and communicable zone notification mode as modes for notifying the user that the PC of the communication partner desired by the user is present in the radio communicable zone. The user can selectively set one of the notification modes. The characteristic features of the two notification modes will be described with reference to FIGS. 2A and 2B.

The search notification mode is effectively used, for example, when the PC 2 of a communication partner of the PC 1 is present among various kinds of electronic devices (other PCs, portable information devices, portable telephones, digital cameras, and the like) and the user of the PC 1 is to visually recognize the position of the PC 2 of a communication partner of the PC 1, as shown in FIG. 2A. On the other hand, the communicable zone notification mode is effectively used, for example, when the PC 2 of a communication partner of the PC 1 moves from the noncommunicable zone to the communicable zone, and the user of the PC 1 is to visually recognize the position of the PC 2, as shown in FIG. 2B. Processing contents by each notification mode will be described below in detail.

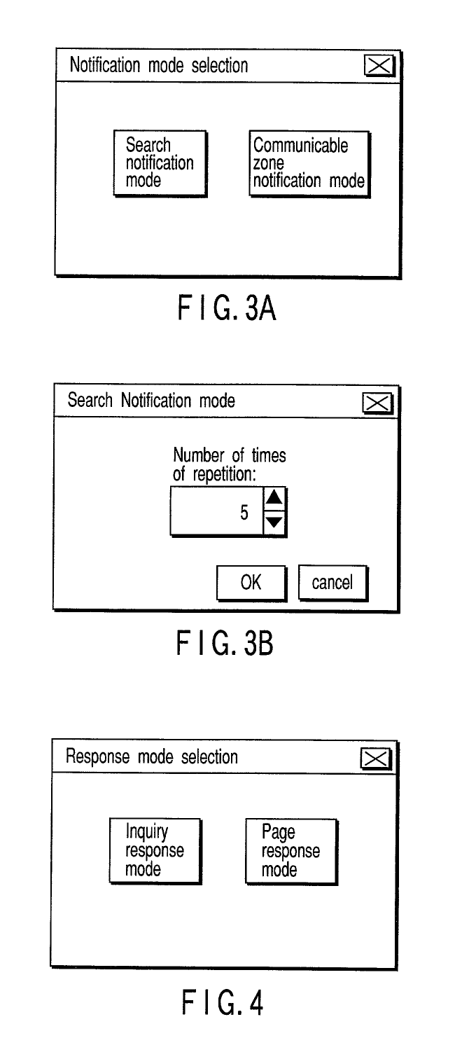

The setting window for the two notification modes will be described below with reference to FIGS. 3A and 3B.

In the notification mode setting window, a window with a search notification mode button and communicable zone notification mode button appears, as shown in FIG. 3A. When the user selects the search notification mode button, a window for designating the number of times of repetition of Inquiry scan (the number of times of trial of Inquiry scan until a response from the desired communication partner is received) appears, as shown in FIG. 3B. When the number of times of repetition is designated by the user, setting of the search notification mode is ended. When the user selects the communicable zone notification mode button in FIG. 3A, setting of the communicable zone notification mode is ended.

The electronic device handled in this embodiment need not always allow the user to select one of the two notification modes. Instead, one of the notification modes may be permanently set in accordance with the type of the device.

Each of the PCs 1 to 3 has response modes in addition to the above-described notification modes. Two response modes, i.e., Inquiry response mode and Page response mode are prepared in accordance with whether the PC should respond to a link request signal (Page scan) which is sent from the inquiry source subsequent to an inquiry as to whether the PC is present in the communicable zone.

In the Inquiry response mode, if the PC is present in the communicable zone, it responds to the inquiry signal (performs Inquiry response) and causes the LED 6 to emit light or causes the buzzer 7 to generate a sound to indicate the presence of the PC. In this Inquiry response mode, even when a link request signal is subsequently received from the inquiry source, the PC does not respond to it (Page response is not performed). In the Page response mode, instead of operating the LED 6 or buzzer 7 in response to an inquiry signal (Inquiry response), the LED 6 or buzzer 7 is operated in response to a link request signal subsequently sent from the inquiry source (Page response). Processing contents by each notification mode will be described below.

The setting window for the two response modes will be described below with reference to FIG. 4.

In the response mode setting window, a window with an Inquiry response mode button and Page response mode button appears, as shown in FIG. 4. When the user selects the Inquiry response mode button, the Inquiry response mode is set. When the user selects the Page response mode button, the Page response mode is set.

The electronic device handled in this embodiment need not always allow the user to select one of the two response modes. Instead, one of the response modes may be stationarily set in accordance with the type of the device.

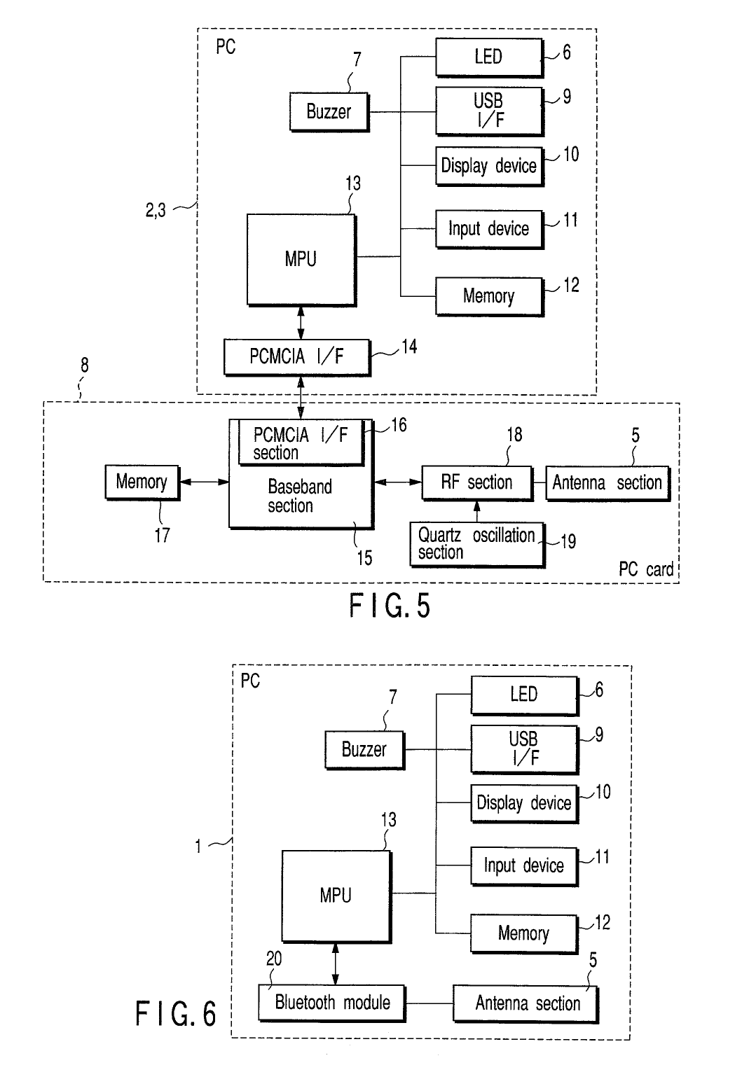

FIG. 5 is a block diagram showing the hardware configuration of the PC 2 or 3 with a PC card inserted.

In addition to the LED 6 and buzzer 7 described above, the PC has a USB (Universal Serial Bus) interface 9, display device 10, input device 11, memory 12, MPU 13, and PCMCIA (Personal Computer Memory Card International Association) interface 14.

The USB interface 9 interfaces between the PC and an external USB compatible device.

The display device 10 is formed from, e.g., an LCD (Liquid Crystal Display) to display various kinds of information such as the above-described mode setting window.

The input device 11 is formed from a keyboard or pointing device and used for various operations such as the above-described mode setting.

The memory 12 stores various kinds of data and programs. The memory 12 stores registration information of the identification number (address called BD_ADDR) of each electronic device which can be connected by radio, mode setting information, and the like.

The MPU 13 controls the overall operation of the PC and executes, e.g., processing for searching for another electronic device in accordance with the program stored in the memory 12 or processing for responding to an inquiry from another electronic device.

The PCMCIA interface 14 interfaces between the MPU 13 and the PC card inserted into the PC card slot of the PC main body.

The PC card 8 inserted into the slot of the PC 2 or 3 has a function as a radio communication module based on Bluetooth and also has, in addition to the above-described antenna section 5, a baseband section 15, PCMCIA interface section 16, memory 17, RF section 18, and quartz oscillation section 19.

The baseband section 15 executes digital processing for a signal received through the antenna section 5 and RF section 18 to convert the signal into data processible by the PC, sends the data to the PC through the PCMCIA interface section 16, or stores related information in the memory 17. The baseband section 15 also reads out information stored in the memory 17 or converts data received from the PC through the PCMCIA interface section 16 into a signal that can be processed by the RF section 18 and transmitted from the antenna section 5.

The memory 17 stores pieces of information related to various functions such as the LMP (Link Manager Protocol), L2CAP (Logical Link Control and Adaptation Protocol), SDP (Service Discovery Protocol), and RFCOMM corresponding to firmware defined by the Bluetooth standard.

The RF section 18 modulates a signal received from the baseband section 15 into a predetermined frequency on the basis of a clock supplied from the quartz oscillation section 19 and sends the signal to the antenna section 5. The quartz oscillation section 19 generates a clock and supplies it to the RF section 18.

FIG. 6 is a block diagram showing the hardware configuration of the PC 1. The same reference numerals as in FIG. 5 denote the same elements in FIG. 6, and a detailed description thereof will be omitted.

The above-described PCs 2 and 3 realize radio communication based on Bluetooth by inserting the PC card functioning as a Bluetooth module. However, the PC 1 incorporates the Bluetooth module in the main body and can therefore realize radio communication based on Bluetooth, like the PCs 2 and 3.

That is, the PC 1 has a Bluetooth module 20 for realizing radio communication based on Bluetooth in its main body. The Bluetooth module 20 interfaces to the MPU 13 and also executes radio communication with another Bluetooth compatible device through the antenna section 5.

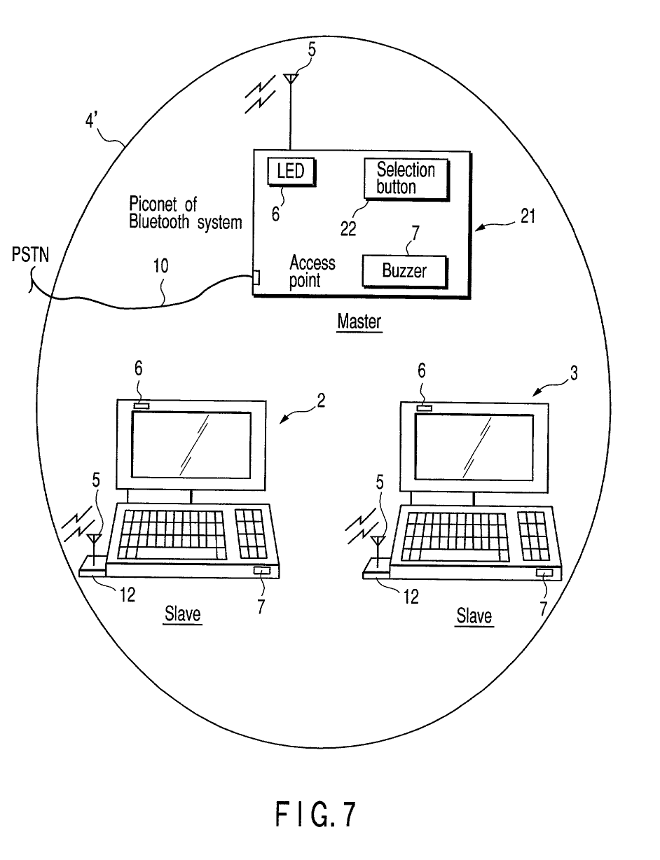

FIG. 7 is a view showing another configuration different from the radio communication system shown in FIG. 1. The same reference numerals as in FIG. 1 denote the same elements in FIG. 7, and a detailed description thereof will be omitted.

In the configuration shown in FIG. 7, the PC 1 in FIG. 1 is replaced with an access point 21. The PCs 2 and 3 and access point 21 form a radio communication system.

The access point 21 is connected to a PSTN (Public Switched Telephone Network) as a public line (telephone line). When the PC 2 or PC 3 is connected to the access point 21 by radio, the PC 2 or PC 3 can communicate with the PSTN.

The access point 21 has a Bluetooth radio communication function in its main body and executes radio communication through an antenna section 5. The access point 21 has an LED 6 and buzzer 7, like the PCs 2 and 3. When the PC of a user is present in the communicable zone, the LED 6 and buzzer 7 are used to indicate the presence of the PC to other PC users. The access point 21 also has a selection button 22. The selection button 22 is used by the user to select and set one of the two response modes described above.

When the access point 21 which has been asked whether it is present in the communicable zone is present in the communicable zone, the access point 21 responds to the inquiry signal (Inquiry response is performed) and also causes the LED 6 to emit light (turns on or blinks the LED 6) or causes the buzzer 7 to generate a sound to indicate its presence. Instead of operating the LED 6 or buzzer 7 at this time, the LED 6 or buzzer 7 may be operated to respond to a link request signal subsequently sent from the inquiring PC (Page response is executed).

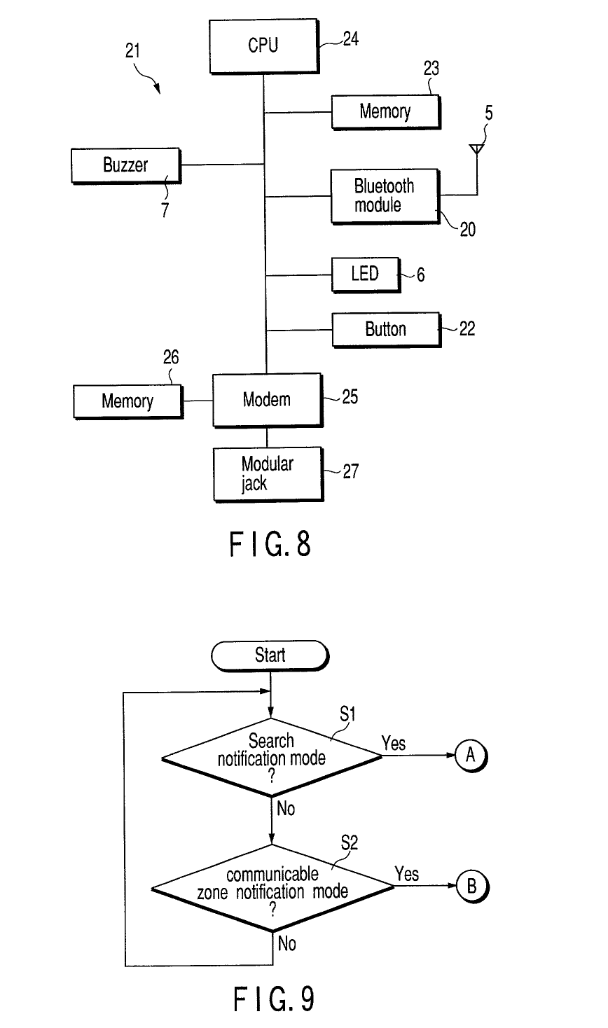

FIG. 8 is a block diagram showing the hardware configuration of the access point 21.

In addition to the above-described antenna section 5, LED 6, buzzer 7, and selection button 22, the access point 21 also has a Bluetooth module 20 that is the same as that shown in FIG. 6, a memory 23, CPU 24, modem 25, memory 26, and modular jack 27.

The memory 23 stores various kinds of data and programs and stores registration information of the device number (address) of each electronic device which can be connected by radio, mode setting information, and the like.

The CPU 24 controls the overall operation of the access point and executes, e.g., processing for responding to an inquiry from another electronic device in accordance with the program stored in the memory 23.

The modem 25 executes connection processing between the PSTN as a public line (telephone line) and the access point main body.

The memory 26 stores, e.g., a program for controlling the operation of the modem 25.

The modular jack 27 is used to connect the signal line from the modem 25 to the public line.

The operation of the radio communication system according to this embodiment will be described below.

A case wherein the PC 1 shown in FIG. 1 searches for the PC 2 will be exemplified here.

The operation of the searching PC 1 will be described first with reference to FIGS. 9 to 11.

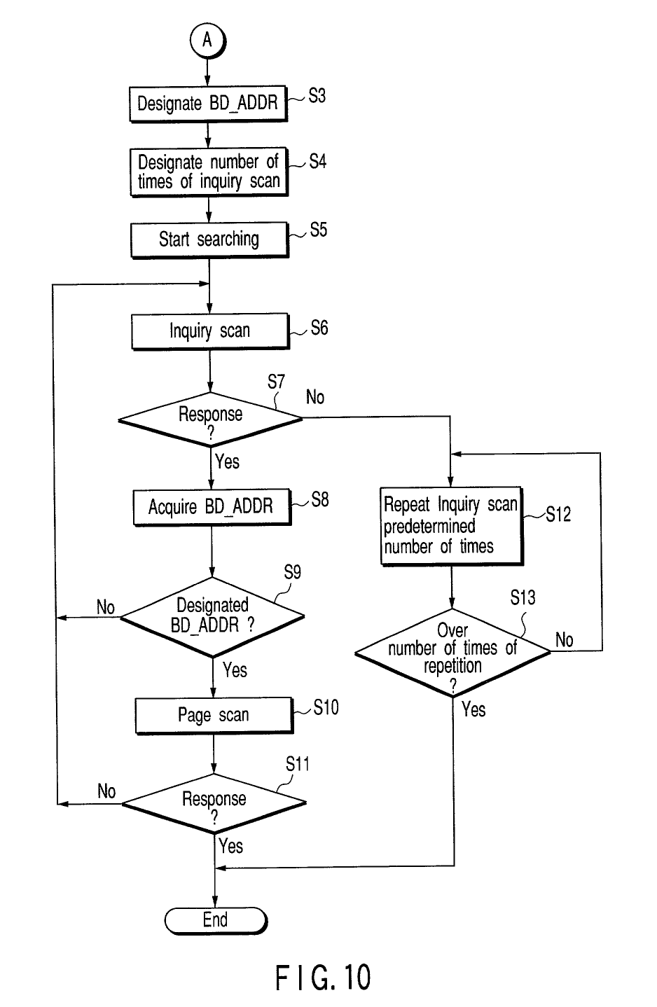

When a predetermined program starts in the PC 1, which of the search notification mode and communicable zone notification mode is selected by the user is determined, as shown in FIG. 9 (steps S1 and S2). If YES in step S1, processing shown in FIG. 10 is executed.

That is, in the PC 1, the identification number (address called BD_ADDR) unique to the PC 2 is designated (step S3), the number of times of Inquiry scan is designated (step S4), and processing for searching for the PC 2 is started (step S5).

To check whether the PC 2 is present in the communicable zone, Inquiry scan is executed from the PC 1 (step S6). It is determined whether a response is received from the PC 2 (step S7). If YES in step S7 (Inquiry response), the BD_ADDR that is simultaneously sent is acquired (step S8). It is determined whether the BD_ADDR matches the previously designated BD_ADDR (step S9).

If NO in step S9, the flow returns to step S6. If YES in step S9, Page scan is executed from the PC 1 (step S10) to send a link request to the PC 2. It is determined whether a response (Page response) is received from the PC 2 (step S11).

If NO in step S11, the flow returns to step S6. If YES in step S11, a link is formed, and the processing of the program is ended.

If NO in step S7, Inquiry scan is repeated until the number of times of repetition exceeds the number of times designated in step S4 (steps S12 and S13). If YES in step S13, it is determined that the Inquiry scan has failed, and the processing of the program is ended.

If the Inquiry response mode is set on the PC 2 side, the LED 6 or buzzer 7 of the PC 2 operates when the PC 2 responds to the Inquiry scan in step S6. On the other hand, if the Page response mode is set on the PC 2 side, the LED 6 or buzzer 7 of the PC 2 operates when the PC 2 responds to the Page scan in step S10.

If YES in step S2 of FIG. 9, processing shown in FIG. 11 is executed.

That is, in the PC 1, the identification number (address called BD_ADDR) unique to the PC 2 is designated (step S12), and processing for searching for the PC 2 is started (step S13).

To check whether the PC 2 is present in the communicable zone, Inquiry scan is executed from the PC 1 (step S14). It is determined whether a response is received from the PC 2 (step S15). If NO in step S15, the flow returns to step S14. If YES in step S7, the BD_ADDR that is simultaneously sent is acquired (step S16). It is determined whether the BD_ADDR matches the previously designated BD_ADDR (step S17).

If NO in step S17, the flow returns to step S14. If YES in step S17, Page scan is executed from the PC 1 (step S18) to send a link request to the PC 2. It is determined whether a response (Page response) is received from the PC 2 (step S19).

If NO in step S19, the flow returns to step S14. If YES in step S19, the buzzer 7 (or the LED 6) of the PC 1 is operated to notify the user of the PC 1 with a beep sound that the PC 2 has entered the communicable zone (step S20). Instead of generating a beep sound, a notification may be done by light or vibration. Alternatively, the window on the display device 10 of the PC 1 may be changed for notification. After this, the processing of the program is ended.

If the Inquiry response mode is set on the PC 2 side, the LED 6 or buzzer 7 of the PC 2 operates when the PC 2 responds to the Inquiry scan in step S14. On the other hand, if the Page response mode is set on the PC 2 side, the LED 6 or buzzer 7 of the PC 2 operates when the PC 2 responds to the Page scan in step S18.

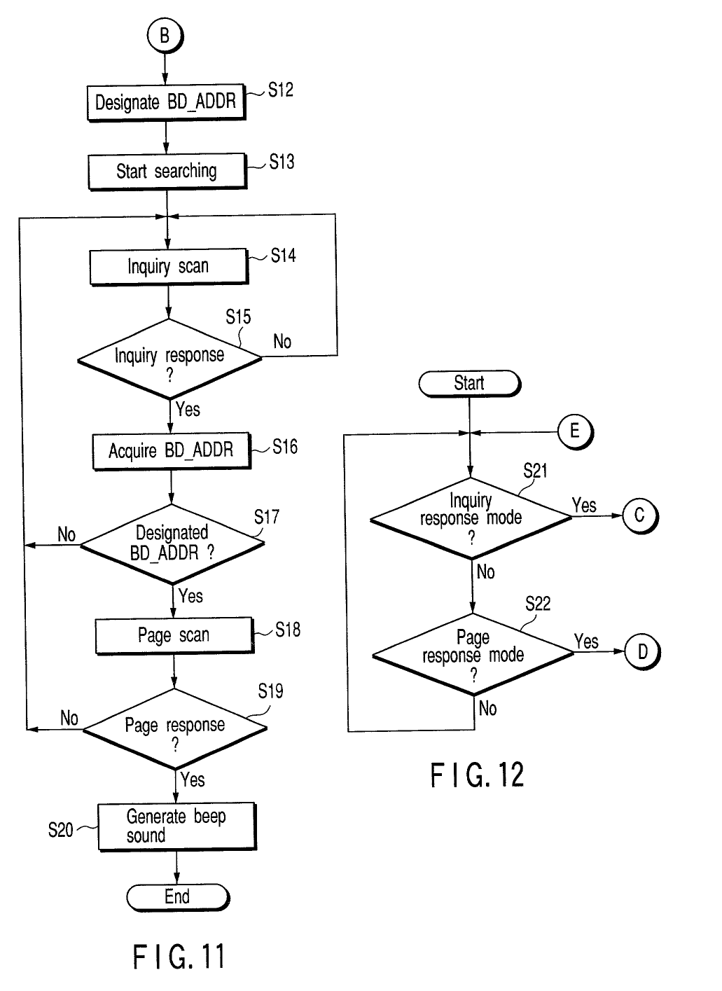

The operation of the searched PC 2 will be described below with reference to FIGS. 12 to 14.

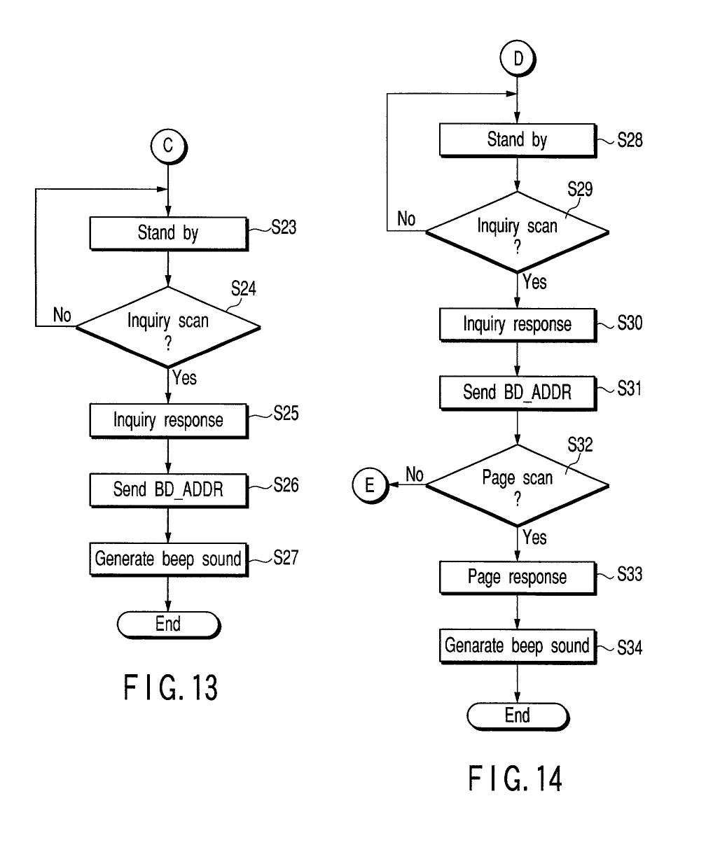

When a predetermined program starts in the PC 2, which of the Inquiry response mode and Page response mode is selected by the user is determined, as shown in FIG. 12 (steps S21 and S22). If YES in step S21, processing shown in FIG. 13 is executed.

That is, the PC 2 stands by until Inquiry scan is executed from another electronic device (step S23) and determines whether Inquiry scan is executed (step S24).

For example, when Inquiry scan is executed from the PC 1, an Inquiry response is sent to the PC 1 (step S25), the BD_ADDR of the PC 2 is sent (step S26), and the buzzer 7 (or the LED 6) of the PC 2 is operated (step S27). When the Inquiry scan is executed from the PC 1, the user of the PC 1 can recognize the position where the PC 2 is present as the LED 6 or buzzer 7 of the PC 2 operates.

If YES in step S22 of FIG. 12, processing shown in FIG. 14 is executed.

That is, the PC 2 stands by until Inquiry scan is executed from another electronic device (step S28) and determines whether Inquiry scan is executed (step S29).

For example, when Inquiry scan is executed from the PC 1, an Inquiry response is sent to the PC 1 (step S30), and the BD ADDR of the PC 2 is sent (step S31). After that, it is determined whether Page scan is executed from the PC 1 (step S32).

If NO in step S32, the flow returns to step S21 of FIG. 12. If YES in step S32, a Page response is sent to the PC 1 (step S33), and the buzzer 7 (or the LED 6) of the PC 2 is operated (step S34). When the Page scan is executed from the PC 1, the user of the PC 1 can recognize the position where the PC 2 is present as the LED 6 or buzzer 7 of the PC 2 operates.

The operations have been described above while exemplifying the case wherein the PC 1 in FIG. 1 searches for the PC 2. The same operations as described above are applied even when the access point 21 in FIG. 7 searches for the PC 2 or the like.

As described above, according to this embodiment, before a piconet is formed, the search notification mode is set, and search is executed. With this processing, even when the electronic device of a communication partner is present among various kinds of electronic devices (other PCs, portable information devices, portable telephones, digital cameras, and the like), the position where the electronic device of the communication partner is present can be visually recognized because the LED or buzzer of the electronic device of the communication partner operates. Alternatively, before a piconet is formed, the communicable zone notification mode is set, and search is executed. With this processing, when the electronic device of the communication partner moves from the noncommunicable zone to the communicable zone, the buzzer of the electronic device of user's own operates, and the LED or buzzer of the electronic device of the communication partner also operates. Hence, when the electronic device of the electronic device enters the communicable zone, the position where the electronic device is present can be visually recognized.

The present invention is not limited to the above embodiments, and various changes and modifications can be made within the spirit and scope of the invention. For example, in one of the embodiments, a PC or access point has a Bluetooth interface. However, the present invention is not limited to this and can also be applied to a PC or access point having another interface defined by IEEE802.11b, IEEE802.12, IEEE802.15, or the like.

In the above embodiments, the PC card 8 having a function as a radio communication module is inserted to each of the PCs 2 and 3. However, any other medium except the PC card can be used as long as it has the function of the radio communication module. For example, an SD memory card, SD I/O card, or stick type memory card may be used. In this case, each of the PCs 2 and 3 may have a corresponding interface section.

As has been described above in detail, according to the present invention, the user can quickly and easily visually recognize the presence of the electronic device of a radio communication partner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication system comprising:
a first electronic device transmitting a search signal for checking whether a communication partner of the first electronic device is present in a communicable zone; and
a second electronic device transmitting a response signal to the search signal and generating an indicating signal indicating that the second electronic device is present in the communicable zone.

2. The system according to claim 1, wherein the second electronic device transmits a response signal to a link request signal and generates the indicating signal in response to the link request signal from the first electronic device.

3. The system according to claim 2, wherein the first electronic device generates a sound in response to the response signal to the link request signal from the second electronic device.

4. The system according to claim 1, wherein the first electronic device repeatedly transmits the search signal until the response signal to the search signal is received.

5. The system according to claim 4, wherein the first electronic device sets the number of times of repetition of transmission of the search signal.

6. The system according to claim 1, wherein the first electronic device designates an identification number of the communication partner, compares the designated identification number with an identification number obtained when the response signal to the search signal is received, and if the identification numbers match, transmits a link request signal to the communication partner.

7. The system according to claim 1, wherein radio communication between the first and second electronic devices is based on Bluetooth.

8. The system according to claim 1, wherein the indicating signal includes at least one of a sound and a light.

9. An electronic device search method applied to a radio communication system including first and second electronic devices capable of forming a radio communication network, the method comprising:
first transmitting from the first electronic device a search signal for checking whether a communication partner of the first electronic device is present in a communicable zone;
second transmitting from the second electronic device a response signal to the search signal when the second electronic device receives the search signal; and
generating from the second electronic device an indicating signal indicating that the second electronic device is present in the communicable zone when the second electronic device receives the search signal.

10. The method according to claim 9, wherein said second transmitting comprises transmitting from the second electronic device a response signal to a link request signal when the second electronic device receives the link request signal from the first electronic device.

11. The method according to claim 10, further comprising generating a sound from the first electronic device when the first electronic device receives the response signal to the link request signal from the second electronic device.

12. The method according to claim 9, wherein said first transmitting comprises repeatedly transmitting the search signal from the first electronic device until the response signal to the search signal is received.

13. The method according to claim 12, further comprising setting the number of times of repetition of transmission of the search signal in the first electronic device.

14. The method according to claim 9, further comprising designating an identification number of the communication partner by the first electronic device, comparing the designated identification number with an identification number obtained when the response signal to the search signal is received by the first electronic device, and if the identification numbers match, transmitting a link request signal from the first electronic device to the communication partner.

15. The method according to claim 9, wherein radio communication between the first and second electronic devices is based on Bluetooth.

16. The method according to claim 9, wherein the indicating signal includes at least one of a sound and a light.

17. A radio communication device for communicating with another radio communication device, comprising:
a radio communication unit executing ad hoc radio communication with the another radio communication device; and
a signal output unit outputting a signal through the radio communication unit to the another radio communication device, the signal causing the another radio communication device to indicate that the another radio communication device is communicable when the another radio communication device is capable of executing ad hoc radio communication with the radio communication unit.

18. The device according to claim 17, wherein the radio communication is based on Bluetooth, and the signal is an inquiry.

19. A radio communication device for communicating with another radio communication device, comprising:
a radio communication unit executing ad hoc radio communication with the another radio communication device; and
a signal output unit outputting a signal through the radio communication unit to the another radio communication device, the signal causing the another radio communication device to generate a sound when the another radio communication device is capable of executing ad hoc radio communication with the radio communication unit.

20. The device according to claim 19, wherein the radio communication is based on Bluetooth, and the signal is an inquiry.

21. A radio communication device for communicating with another radio communication device, comprising:
a radio communication unit executing ad hoc radio communication with the another radio communication device; and
a signal output unit outputting a signal through the radio communication unit to the another radio communication device, the signal causing the another radio communication device to generate a light when the another radio communication device is capable of executing ad hoc radio communication with the radio communication unit.

22. The device according to claim 21, wherein the radio communication is based on Bluetooth, and the signal is an inquiry.

23. A radio communication system comprising:
a first radio communication device and a second radio communication device capable of forming an ad hoc network,
the first radio communication device comprising
a first radio communication unit, and
a signal output unit outputting a signal through the first radio communication unit, the signal inquiring whether the second radio communication device is communicable; and
the second radio communication device comprising
a second radio communication unit, and
an indicating unit receiving the signal through the second radio communication unit and indicating that the second radio communication device is communicable, when the second radio communication device is capable of executing ad hoc radio communication with the first radio communication device.

24. The system according to claim 23, wherein the radio communication is based on Bluetooth, and the signal is an inquiry.

25. A method of searching a communicable partner before an ad hoc network is formed in a radio communication system including a first radio communication device and a second radio communication device, the method comprising:
outputting a signal from the first radio communication device to the second radio communication device, the signal inquiring whether the second radio communication device is communicable; and
receiving the signal and indicating that the second radio communication device is communicable by the second radio communication device, when the second radio communication device is capable of executing ad hoc radio communication with the first radio communication device.

26. The method according to claim 25, wherein the radio communication is based on Bluetooth, and the signal is an inquiry.
